(19) United States
(12) Patent Application Publication
(10) Pub. No.: US 2011/0106607 A1
(43) Pub. Date: May 5, 2011

(54) Techniques For Targeted Offers

(76) Inventors: Chris Alfonso, Mt. Pleasant, SC (US); Walter Lo Faro, Chesterfield, MO (US); Sheryl Sleeva, Norwalk, CT (US); Wendy Murdock, New York, NY (US); Brian Prascak, Rowayton, CT (US); Ruven Cohen, New York, NY (US); Brad Furman, Westport, CT (US); Craig Stanek, St. Charles, MO (US); Chris Merz, Wildwood, MO (US)

(21) Appl. No.: 12/515,002

(22) PCT Filed: Nov. 30, 2007
(86) PCT No.: PCT/US07/86114

§ 371 Date: Dec. 3, 2010

Related U.S. Application Data
(60) Provisional application No. 60/867,983, filed on Nov. 30, 2006.
(60) Provisional application No. 60/867,988, filed on Nov. 30, 2006.
(60) Provisional application No. 60/868,002, filed on Nov. 30, 2006.

(51) Int. Cl. G06Q 30/00; G06Q 40/00

(52) U.S. Cl. 705/14.25; 705/14.53; 705/35

(57) ABSTRACT

Systems and methods for analyzing and segregating payment card account profiles into clusters and targeting offers to cardholders. Offers may be targeted based on analyzing customer transactions with merchants from a merchant category as compared with transactions with merchants from a universe of merchants. Customers who have no transaction history with a merchant may be selected for offers based on similarities with respect to other customers of the merchant. Multiple merchant offers may be combined into a single mailing based on a scoring algorithm.

### RELATED APPLICATION

This application claims priority to U.S. provisional patent applications 60/867,983, entitled Techniques For Targeted Offers To Account Holders From Multiple Merchants and filed Nov. 30, 2006; 60/867,988, entitled Techniques For Targeted Offers To Accountholders Using A Loyalty Matrix and filed Nov. 30, 2006; and 60/868,002, entitled Techniques For Analyzing Cardholder Behavior Using Purchase Cluster Analysis and filed Nov. 30, 2006, each of which are incorporated by reference in their entireties herein.

### BACKGROUND

Merchants often desire to target offers, mailings, and other communications to particular segments of customers to gain the most benefit from their mailing campaigns. They often incentivize customer spending based on rewarding old customers or attracting new customers. Increasing the likelihood that a target customer would transact business with a merchant participating in such a campaign is desirable due to the cost and effort required to undertake such a campaign.

Some techniques for sending offers to accountholders of credit, debit, or other value-based accounts consist largely of randomly selecting accountholders for inclusion in offer campaigns. These techniques yield poor results (e.g., the percentage of customers responding to an offer) because little or no consideration is given to the likelihood of the offers being attractive to the customer. Campaigns may include discounts on future purchases, coupons for use with a particular merchant, coupons applicable when used with a particular payment method, such as a credit or debit card, or other incentives encouraging particular types of consumer behavior. Numerous other types of promotions by merchants and/or card account issuers will be apparent to one of ordinary skill in the art.

Some techniques for targeting customers rely on metrics that have little correlation to the likelihood of a customer making a purchase at a particular merchant. Reasons for this include (1) the inference of customer behavior (i.e., likelihood to purchase) is poor, (2) the customer base is too small or does not capture the target customer class, and (3) the analysis considers too few variables about customer behavior.

### SUMMARY

Systems and methods for techniques for targeted offers are described.

Some embodiments include techniques for targeting an offer to a customer, including retrieving profiles for one or more merchants from a first database, said merchants belonging to a merchant category; retrieving transaction data for said customer from a second database; for a merchant within said merchant category, determining a customer loyalty data with respect to said merchant based at least in part on comparing said customer's transactions with said merchant with said customer's transactions with merchants in said merchant category; assigning said customer to a loyalty category based at least in part on said customer loyalty data; determining a second metric for said customer; and sending said offer to said customer, said offer customized based at least in part on said loyalty category and said second metric. One customer loyalty data can be the ratio of the number of said customer's transactions conducted with said merchant to the number of said customer's transactions conducted with any merchant in said merchant category. Said second metric can be a total amount spent by said customer at merchants in said merchant category. Said second metric can be based at least in part on determining whether customer is geographically eligible for said offer. Said first and second databases can be the same database.

Some embodiments include a computer system including one or more processors and memory for targeting an offer to a customer, including a first database for storing profiles for one or more merchants, said merchants belonging to a merchant category; a second database for storing transaction data for said customer; a loyalty module for determining, for a merchant within said merchant category, a customer loyalty data with respect to said merchant based at least in part on comparing said customer's transactions with said merchant with said customer's transactions with merchants in said merchant category and assigning said customer to a loyalty category based at least in part on said customer loyalty data; a secondary metric module for determining a second metric for said customer; and an offer module for sending said offer to said customer, said offer customized based at least in part on said loyalty category and said second metric. One customer loyalty data can be the ratio of the number of said customer's transactions conducted with said merchant to the number of said customer's transactions conducted with any merchant in said merchant category. Said merchant category can include merchants in a same industry. Said second metric can be a total amount spent by said customer at merchants in said merchant category. Said second metric can be based at least in part on determining whether said customer is geographically eligible for said offer. Said first and second databases can be the same database.

Some embodiments include techniques operable on a computer system for sending offers from multiple merchants to a customer, including retrieving, from a first database, data for a customer class based on a customer selection criteria, said customer belonging to said customer class; retrieving, from a second database, profiles for one or more merchants based at least in part on analyzing transactions between customers in said customer class and said merchants, said merchants grouped in a merchant category; identifying a merchant coalition, said merchant coalition including a subset of merchants from said merchant category; scoring said customer based at least in part on the number of merchants within said merchant coalition with which said customer has transacted business within a preselected time period; determining, for each merchant within said merchant coalition, an offer for said customer based at least in part on comparing the number of said customer's transactions with said each merchant with the number of said customer's transactions with merchants in said merchant category; and sending said offers to said customer based at least in part on whether said customer's score is above a threshold. Merchants for said merchant category can be selected based at least in part on (1) the amount spent, per customer within said customer class, at said candidate merchant, (2) the number of customers within said customer class who conducted transactions with said candidate merchant, or (3) the number of customers within said customer class who conducted transactions with said candidate merchant as compared with a universe of merchants. Said selection criteria can includes customer spend patterns, income, or geography. Said first and second databases can be the same database.

Some embodiments include a computer system including one or more processors and memory for sending offers from multiple merchants to a customer, including a first database for storing data for a customer class including data based on a customer selection criteria, said customer belonging to said customer class; a second database for storing profiles for one or more merchants including profiles identified based at least in part on analyzing transactions between customers in said customer class and said merchant, said merchants grouped in a merchant category; a merchant coalition module for identifying a merchant coalition, said merchant coalition including a subset of merchants from said merchant category; a scoring module for scoring said customer based at least in part on the number of merchants within said merchant coalition with which said customer has transacted business within a preselected time period; an offer module for determining, for each merchant within said merchant coalition, an offer for said customer based at least in part on comparing the number of said customer's transactions with said each merchant with the number of said customer's transactions with merchants in said merchant category; and an offer sending module for sending said offers to said customer based at least in part on whether said customer's score is above a threshold. Merchants for said merchant category can be selected based at least in part on (1) the amount spent, per customer within said customer class, at said candidate merchant, (2) the number of customers within said customer class who conducted transactions with said candidate merchant, or (3) the number of customers within said customer class who conducted transactions with said candidate merchant as compared with a universe of merchants.

Some embodiments include techniques operable on a computer system for automatically analyzing payment transactions, including receiving, from a first database, one or more accounts from a universe of accounts; receiving, from a second database, an account profile for each account, each account profile constructed from said account's payment transactions over a preselected time period; applying seasonality adjustments to said account profiles; clustering said accounts using a self-organizing map technique; determining whether an industry is a driver industry for a cluster based at least in part on comparing an aspect of accounts in said cluster with said aspect of accounts in said universe; and outputting said determination. Said aspect can be industry penetration. Said aspect can be spend per account. Said aspect can be transactions Per account. Some embodiments further include determining inactive accounts based on an inactivity criteria; and normalizing said inactive accounts. Said first and second databases can be the same database.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1 depicts an example procedure according to some embodiments of the described subject matter.

FIG. 2 depicts example components according to some embodiments of the described subject matter.

FIG. 3 depicts an example procedure according to some embodiments of the described subject matter.

FIGS. 4 and 5 depict example visualizations according to some embodiments of the described subject matter.

FIG. 6 depicts an example chart according to some embodiments of the described subject matter.

FIG. 7 depicts an example procedure according to some embodiments of the described subject matter.

FIG. 8 depicts example components according to some embodiments of the described subject matter.

### DETAILED DESCRIPTION

The described subject matter generally includes techniques for targeting an offer to a customer, including retrieving profiles for one or more merchants from a first database, said merchants belonging to a merchant category; retrieving transaction data for said customer from a second database; for a merchant within said merchant category, determining a customer loyalty data with respect to said merchant based at least in part on comparing said customer's transactions with said merchant with said customer's transactions with merchants in said merchant category; assigning said customer to a loyalty category based at least in part on said customer loyalty data; determining a second metric for said customer; and sending said offer to said customer, said offer customized based at least in part on said loyalty category and said second metric.

In one embodiment of the described subject matter, for each merchant, an accountholder's loyalty to that merchant, as compared to that merchant's category, is calculated and classified. For example, the classification may be High, Low, or None (the latter designation assigned to accounts with no purchases at the merchant, or “Merchant Inactive”), although other classification methods are possible. Similarly, an accountholder's spend among the merchants in the merchant category (often labeled as “Category Spend”) is also calculated and classified. For instance, the classification may be High, Low, or None (here, the latter means no purchases among the merchant category, or “Category Inactive”), although other classification methods are possible.

The result of these classifications may be used to form a matrix of Loyalty and Category Spend combinations. Different types of offers may then be tailored to each combination. For example, in one embodiment, merchants may go beyond their existing customer base and target buyers from other merchants in the category that are not buyers of their own brand (e.g., Category Active but Merchant Inactive). Although merchants often have data on their own customers and create “loyalty” programs designed around recency or frequency of visits, such approaches can lack data from customers who transact business with other merchants in the category. As a result, merchants may not be aware of their customers' spending habits at competing establishments and may not reach likely purchasers.

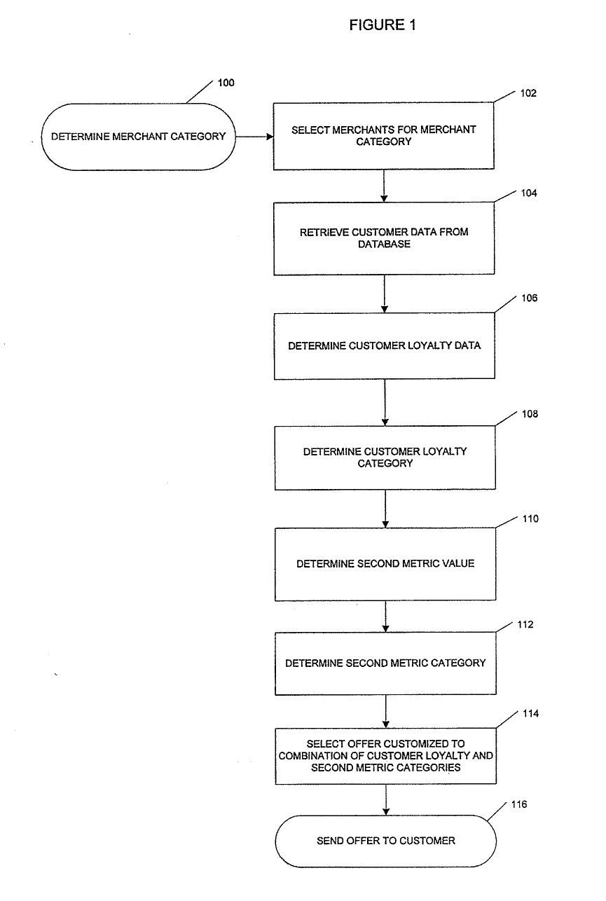

FIG. 1 depicts an example procedure according to some embodiments of the described subject matter. A merchant category may be determined (blocks 100 and 102) according to the requirements of the analysis to be conducted. For example, a merchant category may include all merchants within a particular industry. Such a delineation may be used where a merchant wishes to target offers to customers who have conducted few transactions with the merchant but who have shown spending patterns with other merchants selling similar goods. In other embodiments, a merchant category may include a segment of a particular industry (such as all merchants within a particular geographic region or merchants falling within a specific price range), all merchants in two or more industries (perhaps where merchants in the industries compete for the same customers), etc. In some embodiments, the merchant category may be defined using merchant category codes according to predefined industries as compiled by MasterCard's Merchant Technical Services group, which may align these industries according to the North American Industry Classification, using standard industrial classification codes, or using the industry categorization shown in Table 2, herein.

Data over a given time period may be gathered and analyzed (block 104). For example, the most recent twelve (12) months of transactional data may be processed. Data may be gathered from a customer transaction data database, such as payment card (e.g. credit or debit card) transaction data.

Determining customer loyalty (block 106) includes comparing a metric of a customer's behavior with a merchant within the merchant's category as compared with the same metric for the customer's behavior with respect to other merchants in the category. For example, a customer with 20 transactions with a particular merchant and 30 transactions with all merchants in the category can have a greater loyalty rating than a customer with 5 transactions with the same merchant and 20 transactions with all other merchants in the category. In one embodiment, loyalty may be determined by the percentage of transactions conducted with a merchant as compared to the merchant's category. In another embodiment, a percentage of total amount spent at a merchant as compared to the merchant's category may be used. In other embodiments, transaction frequency, recency, or combinations of the foregoing may be used.

Customers may be classified into a loyalty category (block 108) depending on their loyalty with respect to the merchant. The range of all possible loyalty values may be divided into one or more non-overlapping, contiguous range of loyalty values. In one embodiment, the values may not be contiguous. Each category may consist of one or more values from the entire range. In one embodiment, the loyalty values range from 0 to 100. In one embodiment, the categories may be divided according to the median value of all loyalty values of customers being analyzed.

In one embodiment, one or more offers may be customized for each loyalty category. For example, a frequency reward may be offered to customers with high loyalty with respect to the merchant. An offer designed to attract customers from competitor merchants within the category may be given to customers with low loyalty.

In some embodiments, a second metric may be determined or calculated for the customer (block 110). The customer may fall into a category (block 112) based on evaluation of the second metric. A merchant may target an offer to the customer based on the customer's loyalty category and category derived from the second metric.

The second metric may include any aspect of a customer, for example, a customer's geography. For example, a merchant may wish to provide extra incentives for customers at a closer or greater distance from the merchant to transact business with the merchant. Other metrics may include a customer's income, total yearly spending, average dollar amount per transaction, total amount spent at the merchant or at all merchants in the category, etc. In some embodiments, the second metric may be a second loyalty value. For example, where the first value included the number of transactions, the second loyalty value may include the total spent by the customer. Such a scheme would allow a merchant to target customers that have a large number of transactions with the merchant but who spend relatively little per transaction as compared with other merchants in the category. In one embodiment, the second metric of a customer's geography may be used to determine whether the customer is eligible for the offer. For example, a local merchant may not wish to send offers to any customers outside of a 100 mile radius. In one embodiment, an evaluation of the second metric may be placed into a contiguous range of values for the second metric. The entire range of second metric values may be split into two or more contiguous or non-contiguous ranges.

The combination of customer loyalty and second metric may form a matrix of values. One or more offers may be targeted to each portion of the matrix, and customers falling into particular portions may be given the appropriate offer (blocks 114 and 116). In one embodiment, more than one additional metric may be used, resulting in an n-dimensional matrix.

In one embodiment, one category of the loyalty or additional metrics may include an “inactive” portion. This category may denote customers who have no relevant activity with respect to the loyalty or metric being measured.

The following table shows a sample matrix.

TABLE 1
Offer Matrix

Merchant Loyalty

| | | Inactive | Low | High |
|---|---|---|---|---|
| Category | High | Offer “A” | Offer “B” | Offer “C” |
| Spend | Low | Offer “D” | Offer “E” | Offer “F” |
| | Category | Offer “G” | N/A | N/A |
| | Inactive | | | |

Accounts falling into the “Offer ‘A’” box are those with high spend in the merchant's industry, but no spend at the particular merchant. Therefore, this is not a current customer of the merchant, but is known to buy goods or services from the merchant's competitors, making the account a highly valued potential addition to the merchant's customer base. In contrast, accounts in the “Offer ‘G’” box are those with no spending with the merchant or its competitors, and are therefore potentially less likely to respond to an incentive offer.

In another example, the matrix may include different numbers of levels for each matrix (e.g., a three by three, three by four, or four by three matrix, etc.). Instead of “high,” “low,” and “inactive” for category spend and merchant loyalty, the categories may include “high,” “medium,” “low,” and “inactive” levels.

In some examples, customers may be recategorized based on one or more criteria. For example, a customer whose merchant loyalty is high based on a single large transaction in the category (e.g., a home stereo purchase, or a large business lunch purchase) may be moved to a “low” level to better characterize the transactional behavior of the customer. Alternatively, these customers may be assigned a separate ranking, such as “single transactors,” rather than categorizing them into the matrix methodology described above, and treated as low loyalty customers for purposes of assigning targeted offers or other marketing incentives or communications.

In yet another example, a category spend inactive-ranked customer may be recategorized based on the customer's spending patterns across a larger set of transactions. For example, a customer who is inactive in the particular merchant category but who falls in a high level in several other categories may be targeted to receive the same offer as high level customers in the current category. This would be advantageous to target prospects that exhibit high-loyalty spending patterns in other merchant categories, but have not made purchases in the category being analyzed. Similarly, a customer whose transactions as a whole are similar to customers in the high level category but who are inactive in the current category may be targeted with the same offer as those in the high level category. Other recategorization criteria can include a customer's yearly income, particular types of goods purchased, length of time since the last purchase, and whether the customer's purchases are seasonal.

Once a particular offer has been designated for a customer, the offer may be sent to the customer. Offers may be sent in any appropriate way, such as by inclusion in credit card statements; as separate, direct mailings; by email; by telephone, using an Internet webpage; or other communication channels.

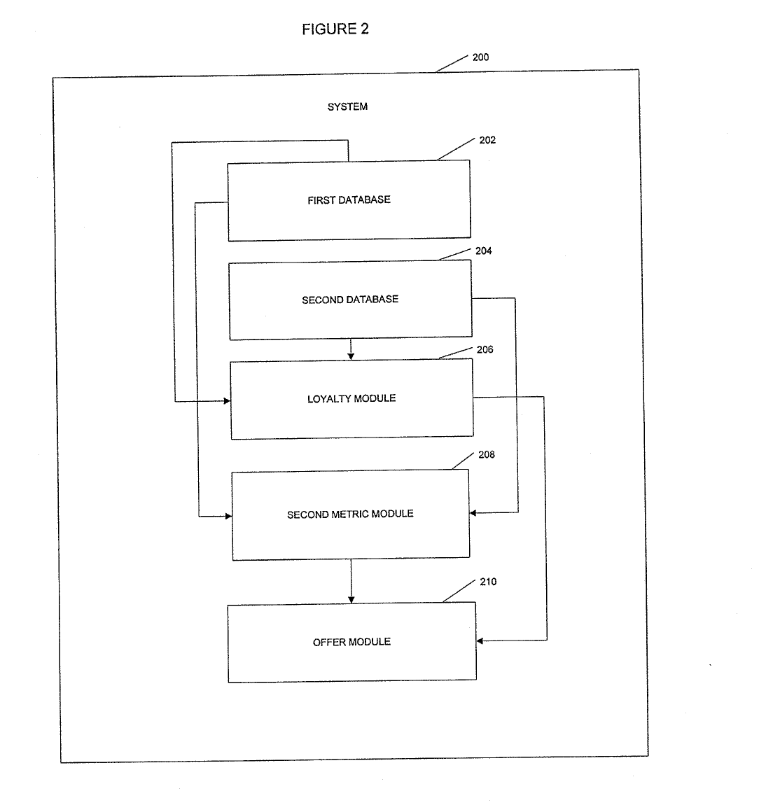

FIG. 2 depicts example components according to some embodiments of the described subject matter. A system 200 includes a first database 210 for storing profiles for one or more merchants, the merchants belonging to a merchant category. For example, the merchants may be those categories found in Table 2. A second database 204 may store transaction data for the customer. For example, the second database may include a database of customers from one or more payment card providers, payment card networks, or other database of transaction information. A loyalty module 206 may determine, for a merchant within the merchant category, a customer loyalty data with respect to the merchant based at least in part on comparing the customer's transactions with the merchant with the customer's transactions with merchants in the merchant category and assigning the customer to a loyalty category based at least in part on the customer loyalty data. The loyalty module may receive data from the first and second databases 202 and 204.

TABLE 2
Industry Codes

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable |
| | Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

A secondary metric module 208 may determine or calculate a second metric for the customer. An offer module 210 may send the offer to the customer, the offer customized based at least in part on the loyalty category and the second metric.

The components of FIG. 2 may be implemented on a single or distributed computing platform including one or more processors, memory, storage devices, input devices, and output devices. Although not shown, databases 202 and 204 include necessary processor and control circuitry to permit the database to be accessed, searched, and otherwise utilized. In one embodiment, the first and second databases 202 and 204 may be the same database.

Another aspect of the described subject matter involves segmenting credit card accounts according to transaction behavior, and leveraging the segmentation for campaigns in, for example, activation of issued cards, usage and retention of existing cards, and acquisition of new cards. The use of databases to create or analyze purchasing clusters is generally described in U.S. Pat. No. 7,035,855 to Kilger et al., which is incorporated by reference herein in its entirety.

In accordance with this aspect of the present invention, transaction data and consumer credit spending profiles (which may include data obtained from the MasterCard Worldwide Account Data Mart (ADM)) are used to create and analyze a set of clusters. The transaction data may consist of a set of a sample of transactions from a given year, including, for example, purchase date, purchase amount, merchant and/or industry identifiers and/or classification identifiers. In one embodiment, standard industry classification codes are employed. Alternatively, modified industry classification codes may be used. In one example embodiment, merchants are divided into approximately 100 different classifications. Examples of industry codes include women's apparel, men's apparel, toys, groceries, office supply chains, gas stations, department stores, etc. One possible list of industry codes for use in the presently described subject matter is contained in Table 2, above.

The transaction data may be used to analyze candidate cluster solutions, finalize the number of clusters, and characterize the spend patterns of each cluster by identifying “driver” industries.

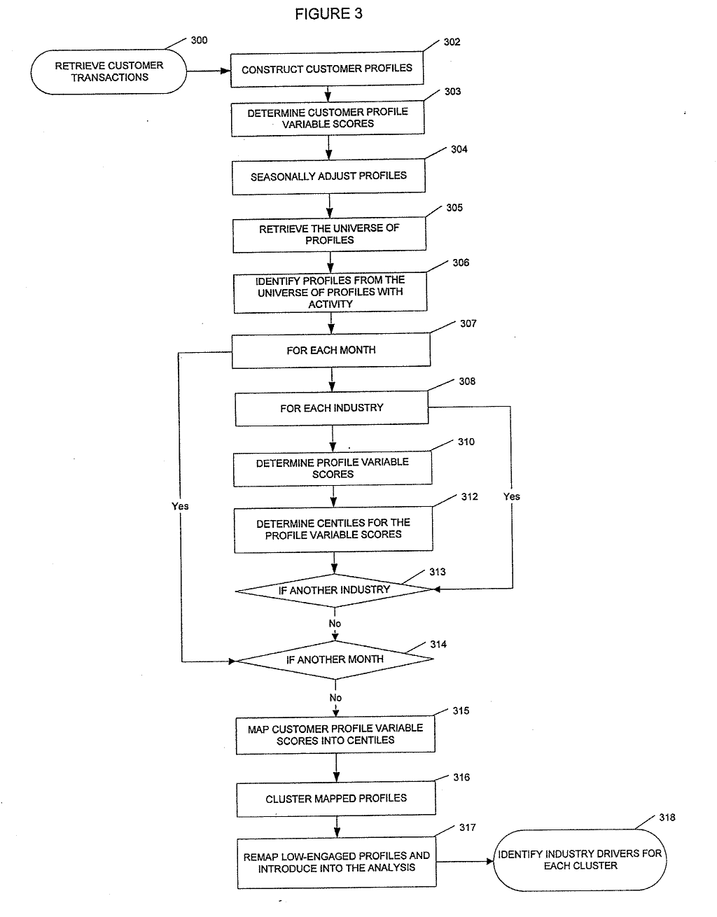

FIG. 3 depicts an example procedure according to some embodiments of the described subject matter. In one embodiment, customer transactions may be retrieved for a given time period (block 300), for example, for the past year, and customer profiles may be constructed (block 302). The profiles may consist of a set of account-level snapshots sampled over a given year. For example, a profile may include a set of profile variables. Each variable may represent aged frequency and dollars spend variables for each industry code. Profile variables may capture the accountholder's transaction patterns for a particular length of time by considering transactions from the most recent to a cutoff time in the past. Aged frequency may take into account that transactions that occurred long in the past may have less applicability than more recent transactions. In another embodiment, profiles may be updated as the accountholder engages in new transactions. One example account profiling technique is contained in U.S. patent application Ser. No. 10/800,875, entitled “Systems and methods for transaction-based profiling of customer behavior” to Chris Merz, filed on Mar. 15, 2004, which is incorporated by reference herein in its entirety.

In one embodiment, profile variable scores may capture transaction velocity, which may include the rate at which the accountholder engages in transactions in the target industry. In another embodiment, profile variable scores may represent spend velocity, which may include the rate at which the accountholder spends in a particular industry. The profile variable score may also include a dollar amount of transactions spent by an accountholder in a particular industry. In another embodiment, the profile variable score may be aged. For example, in determining, calculating, or updating the profile variable score, a decay function may give less weight to earlier transactions and greater weight to more recent transactions. The decay function may eliminate all transactions (giving them a weight of 0) older than one year. In another embodiment, an inverse function may be applied to the age of the transaction, and the resulting value may be multiplied with the transaction value. The profile variable score may thus be determined by summing the aged transaction values.

In other embodiments, the profile variable score may be based on more than one industry, or may be industry neutral (for example, capturing attributes such as “family oriented,” “value shopper,” “college aged,” etc.). A mapping function may exist to map transactions to the relevant profile variable. For example, all transactions from baby goods stores, toy stores, and home improvement stores may be mapped to a “family oriented” profile variable. In some embodiments, profiles used in the analysis of the described subject matter may use the most recent set of profiles from the target set of accountholders.

In one embodiment, the profiles may be seasonally adjusted (block 304) to take into consideration overall spend patterns for different times of the year. Profiles from a universe of profiles may be selected (block 305). For example, all accounts within a universe of accounts that have been in existence for more than six months and had activity in the past three months may first be identified (block 306). “Activity” includes a retail sales transaction with an amount greater than $0. In another embodiment, “activity” may be determined based on whether the customer has visited the store at all, such as to return or exchange merchandise, or for other purposes. In other embodiments, values other than 6 and 3 months may be used. Profile variable scores (such as transactional velocity and spend velocity) for each industry for each of these accounts may be determined (blocks 307, 308, and 310). For each profile variable, centile ranges may be created (block 312) by rank ordering the scores and determining break points for the ranges. The upper end (99th centile) may be open-ended at the top, while the lower end (0th centile) may be open-ended at the bottom. Other centiles may include the previous centile's maximum value as its minimum in order to make the ranges all-inclusive in terms of values. This may ensure robust application of the centiles to accounts that may not have been used to create them. Alternatively, the centile ranges may adjoin one another but may not overlap, thereby also ensuring that a profile variable score will fall into only one centile range. This procedure may be repeated (blocks 313 and 314), for example, monthly, thereby establishing centiles throughout the year. The centile break points for any given month can be different so that the same profile variable score at one time of the year may correspond to a different centile as compared to the same exact score at another point in time. For example, a high profile score for spend in the toy industry may place the score in a lower centile in December than in July due to the general pattern of purchasing toys for the Christmas holidays. This may mitigate seasonality effects that may appear in the absolute profile variable scores. The profile variable scores under analysis may be mapped into the corresponding centiles (block 315), for example, to show the relative amount of transaction activity for the accountholder, as compared to a universe of accountholders, in a particular industry.

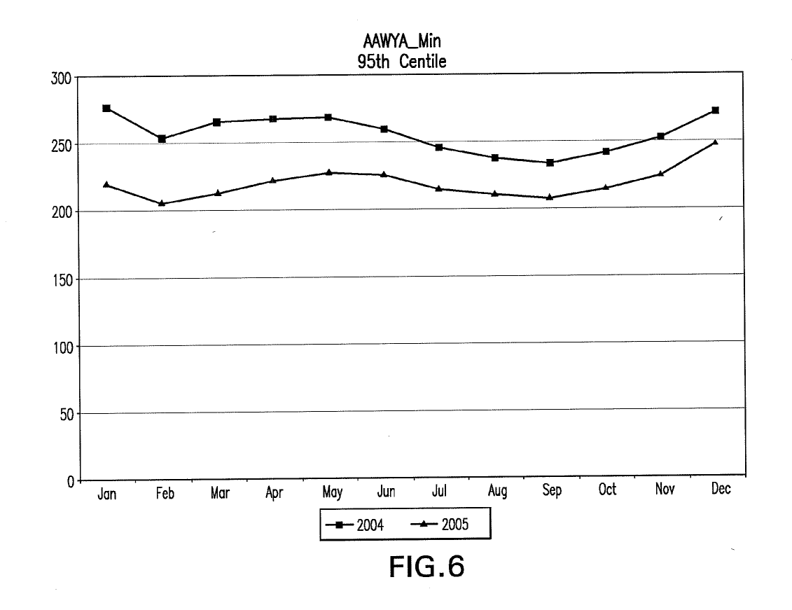

FIG. 6 depicts an example chart according to some embodiments of the described subject matter. Chart 600 of FIG. 6 shows how a seasonality adjustment may be accomplished over the course of a two-year period. The lines plotted represent the cutoff for the 95th percentile for Women's Apparel. The horizontal axis shows the month of year, and the vertical axis shows the raw profile score. Clearly, the cutoff for the 95th percentile changes in a seasonal way. Near the holiday season in December the breakpoint is higher than in September.

Returning to FIG. 3, the seasonally adjusted profiles may be clustered using a clustering technique (block 316). In one embodiment, a K-means clustering technique may be used. Other embodiments may employ a self-organizing mapping technique. Such techniques are described in “Self-Organizing Maps” by T. Kohonen (1997) published by Springer-Verlag, which is hereby incorporated by reference in its entirety. In one technique, a map may initially include a plurality of regions. Each region may include initial features that differentiate the region from other regions. The map and regions may be visualized by a plurality of circles, each circle containing a centroid. The centroid may be associated with the features for the region. An account profile (for example, represented by a colored dot) may be placed into the region that contains the most similar features as the profile. As each new profile is introduced, it may be placed on the map in accordance with how similar the features of the profile match with other profiles in the map. Once the profile is placed, surrounding profiles may be changed (for example, by changing or brightening colors) to appear closer in appearance to the added profile. In this way, profiles that are the most similar may be represented by the same or a similar color and be located in close proximity, while dissimilar profiles may be represented by different colors and may be further from each other.

One embodiment of the market segmentation or clustering aspects of the described subject matter includes the ability to partition a set of accounts into subsets that are both distinct from one another and uniform within themselves. Distinct clusters can be valuable in a targeted marketing campaign, but can be especially so when combined with an accurate understanding of what makes each cluster unique. Gaining this understanding has traditionally been done in a fairly qualitative manner which may lead to a lack of confidence in any conclusions drawn. Therefore, one embodiment of the described subject matter entails quantification of this process, allowing the determination of industry drivers in a particular cluster of accounts, which may be used to differentiate the candidate clustering solution (block 318). The driver metrics employed in the present invention may include absolute drivers, that indicate spend that is above or below the rate of the general population, or relative drivers, that indicate percentage spend that represents high or low cardshare compared to the general population. Exemplary relative statistics include Industry Penetration Index (ip_index), that indicates the percentage of accounts shopping at that industry versus the universe; Spend Per Account Index (spa_index), that indicates the percentage of dollars spent at that industry versus the universe; and Transactions Per Account Index (tpa_index), that indicates the percentage of transactions at that industry versus the universe. The statistics may be derived as follows:

ip_index=100*ip_cluster/ip_overall

Where ip_cluster is the industry penetration for the cluster and ip_overall is the overall industry penetration. Similarly,

spa_index=100*spa_cluster/spa_overall

and

tpa_index=100*tpa_cluster/tpa_overall

It is contemplated that other statistics and other procedures for calculating the foregoing statistics may be used. In prior art techniques, if an index for a cluster was greater than 120, the industry was said to be a “significant” driver for that industry. Using those traditional methods on an example data set might reveal that in the grocery industry (code GRO), the cluster 5 ip_index is 108.89, which is less than 120. Accordingly, under the prior art technique, one would conclude that cluster 5 accounts do not shop at grocery stores much more than the population in general.

If a large random sample is drawn from a population and a statistic is computed for the sample, then the statistic is close to its corresponding parameter. Typically one draws such a sample in order to infer the value of the parameter. In one embodiment of the present invention, the approach is somewhat reversed. The population is all of the accounts in the exercise and the sample is the cluster. Given a computed parameter of the population of accounts in the exercise and a specific cluster, it is useful to ask: what is the probability that the corresponding statistic for a random sample of size equal to the cluster is less than the cluster's statistic? The result of this calculation will be termed the “Driver Finder.” For industry penetration, let m be the number of accounts in the cluster, n be the number of accounts in the cluster in a specific industry, and ip_overall be as above. Then for a uniform random sample of size m, the distribution of the statistic n is binomial with parameters n and ip_overall. For example, for a particular cluster, the following values may be determined:

| | | | | | Driver |
|---|---|---|---|---|---|
| Cluster | Industry | ip_overall | m | n | Finder |
| 5 | GRO | 0.4586 | 833 | 416 | 0.992 |

Interpreting these numbers, Cluster 5 has 833 accounts, of which 416 spent at a grocery store. The value of 0.04586 for ip_overall indicates that in the overall population, 45.86% of accounts made purchases at grocery stores. If a uniform random sample of 833 were drawn from the population, the probability that fewer than 416 of them spent at a grocery store is 99.2%. Therefore, the confidence level to which it can be surmised that accountholders in cluster 5 shop at grocery stores more often than the general public is 99.2%. This indicates that the grocery industry is a significant driver for Cluster 5, a fact that would have been missed previously.

Similar calculations may be performed for Spent Per Account and Transactions Per Account, except that probability density functions for those metrics are not binomial, but are instead approximately Gaussian, as is expected from the Central Limit Theorem.

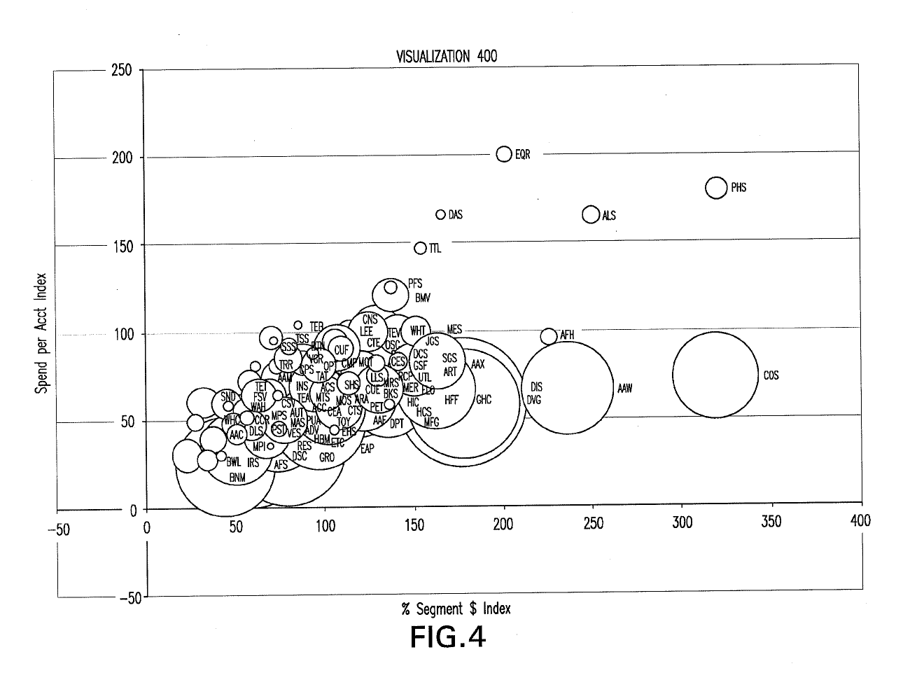

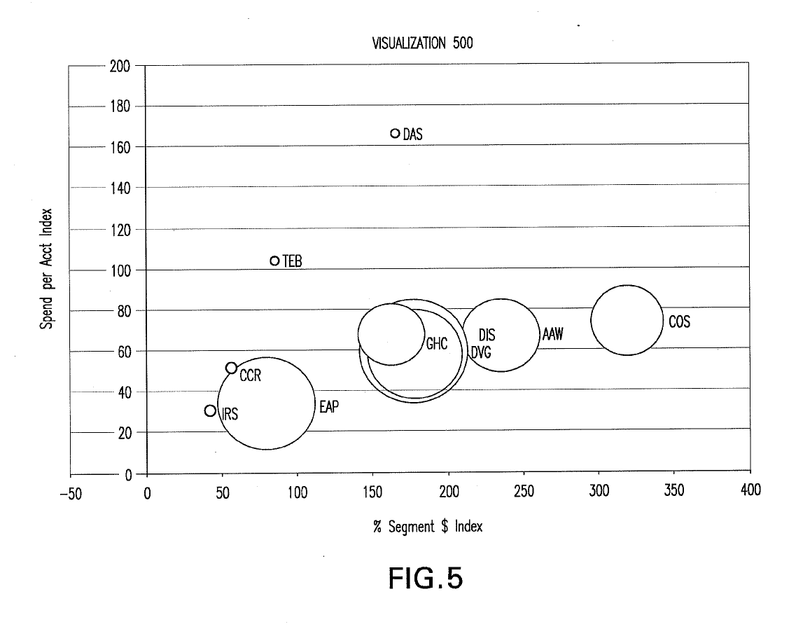

FIGS. 4 and 5 depict example visualizations according to some embodiments of the described subject matter. They illustrate how the penetration driver detection metric may assist in the understanding of a cluster at the industry level. Both charts depict the same (arbitrarily selected) cluster. Visualization 400 of depicts an unfiltered visualization. Visualization 500 depicts a visualization of data filtered to include only those drivers that pass the statistical significance test of the driver detection metric. The horizontal axes reflect percentage of dollars spent index (a measure of relative priority by industry), and the vertical axes show spend per account index (an absolute measure vs. the general population by industry). The size of each bubble indicates the percent of account penetration at each industry.

In visualization 400, every industry appears because no test for significance is performed. Note that some industries with high indices, like PHS, are present in FIG. 4 but are absent in FIG. 5 because the penetration rate is not significantly high.

A natural consequence of payment card data is that many of the cards in the data warehouse will eventually become idle. As a result, any segmentation scheme applied to the profile data will likely have one or more segments with relatively low activity. Typically, the cards landing in this segment were quite different in the prime of their activity, but those distinctions are lost as the profile variables fade away with passing time.

To alleviate this problem, in one embodiment of the described subject matter, a technique is employed for mapping “low usage” card profiles into clusters based on historical spend patterns (block 317). The advantage of this technique is that it enables marketers to leverage a more meaningful and descriptive understanding of the “low engaged” cards for messaging in reactivation campaigns.

In some embodiments, the profiles may be normalized according to a selected norm. For example, the L_{—}1 norm is defined as follows:

Profile_variable′ᵢ=Profile_variableᵢ/sum over j(|Profile_variableⱼ|)

Where

i denotes the i-th profile variable

j ranges from 1 to the total number of profile variables

This normalization re-establishes the profile variable to a level similar to that of an active profile. The transformed profile (using normalized profile variable data) can then be placed in a segment or cluster that most resembles the segment it would have been placed in if the account were still active.

An experiment was conducted to assess the ability to remap low-engaged clusters (e.g., cluster 15). A set of cards in cluster 15 in December of 2004 were identified. Those cards that were not in cluster 15 in the previous months were extracted. For those cards, the remapping technique was applied to the December version of the profile to see whether it would correctly place that card in the penultimate cluster assignment, from November. The table below summarizes the results for various accuracy measures.

| Accuracy Measure | Accuracy |
|---|---|
| Exact Match | 45% |
| City block Distance = | 54% |
| 1 | |
| City block Distance = | 63% |
| 2 | |

The Exact Match metric indicates that the remapped cluster assignment matched the last non-cluster 15 assignment from November 2004. The City block Distance measure of 1 indicates whether the remapped cluster assignment was a node in the SOM that was adjacent to the actual node, i.e., immediately above or below, or to the left or right. The City block Distance of 2 also includes nodes that were diagonal to the November 2004 assignment, e.g., up one and over to the left, up one and over to the right, down one and over to the left, down one and over to the right. The latter two measures consider the fact that nodes near one another in the map are similar in nature.

The fact that an exact match was made in the above example 45% of the time is larger than guessing, i.e., 1/35. The lift—a standard measure in modeling—in that case would be 15.75, meaning the example level of accuracy is 15.75 times better than chance. The remapping technique may also be proficient at placing an account that has become low-engaged back in the general region of the map from which it came. This enables migration analysis even when historical assignments are not available.

The principles of the purchase cluster analysis may be implemented on a computing platform including one or more processors, memory, communication devices, and data storage devices using software or firmware programmed to implement the techniques previously discussed. The results from the analysis may be provided to other procedures or may be presented to the user using an appropriate output device, and may be used for various purposes previously discussed. The calculated profiles and source transaction data may be stored on one or more databases.

Another embodiment of the described subject matter entails a procedure implemented in hardware or software for managing a marketing campaign involving direct communications via mail, email, telemarketing, or other communications media, involving a synergistic and non-competitive group of merchants that are brought together to provide targeted/segmented offers to accountholders based at least in part on their spending preferences, lifestyle and other behavioral patterns on behalf of participating card/account issuers. The described subject matter uses past and present transaction data to categorize customers into multiple loyalty segments based on their purchase history with the participating merchants as compared to the merchants' competitive set, as previously described. The categorized accountholder segments may then qualify for differentiated offers derived out of this Loyalty Matrix, such as is shown in Table 1 above, to maximize various merchant objectives.

Various geographic data may be analyzed, and accountholders may be targeted in the areas that the merchants have the most presence or have under-performing stores. In other embodiments, Purchase Cluster Analysis may be used wherein, to help with acquisition objectives, offers are mailed to accountholders who do not have prior spend history at the merchants but have similar behavioral and attitudinal characteristics (e.g. are in the same cluster) as the merchants' loyal customers.

Multiple credit and/or debit card or account issuers can simultaneously participate in the offering from the merchant coalition, by targeting offers to various accountholders of the issuers, using a similar segmentation methodology. In other embodiments, combinations of single issuer and multiple merchants or multiple issuers and single merchant are contemplated, permitting various merchants and issuers to flexibly achieve business objectives in a targeted communication.

Another exemplary embodiment involves delivery of offers that are customized using a selective insertion technique, whereby multiple combinations of offers from various merchants can be placed into envelopes at the mailing/fulfillment entity, resulting in unique combinations for the cardholders.

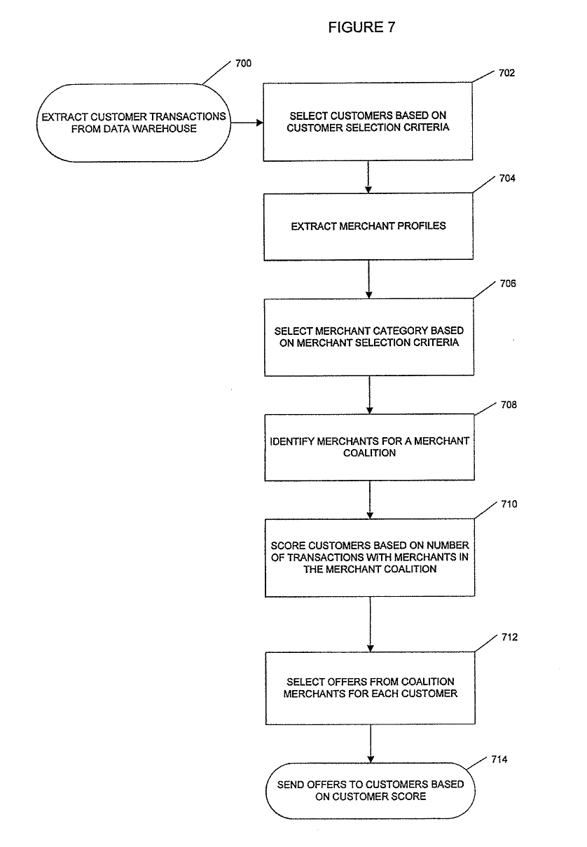

FIG. 7 depicts an example procedure according to some embodiments of the described subject matter. In one embodiment, the segment of consumers to target for a promotion based on the overall objectives of the program may be identified using a customer selection criterion (block 702). Consumer profiles and transaction history may be extracted from one or more data warehouses (block 700). It is contemplated that data warehouses involving multiple issuers may be combined depending on the goals of the program. For example, mass affluent, Premium affluent or Rewards segment consumers may be targeted. Where the target customer base includes affluent customers, a high spend card base (based on total card spend, credit worthiness, or other measures) may be extracted from the data warehouse or other transaction databases, and examined in terms of spend behavior and areas of most spend.

In one embodiment, merchants for the mailing program may be selected by analyzing the body of consumer transactions. A merchant selection criteria may be applied depending on the requirements of the mailing program. For example, to identify merchants with strong consumer activity in the consumer set, merchants that have a disproportionate share of the cardholder spend when compared to a general population as well as within their competitive set may be selected. In other embodiments, to identify merchants who may desire to build their consumer bases, merchants who have the least consumer activity in the consumer set may be selected.

The merchant selection criteria may include various metrics: (1) Spend per account, (2) Penetration percentage—which includes what percentage of the cards in the population purchased at the merchant during a given time frame, and/or (3) Penetration Index—which includes a relative measure comparing the penetration percentage of the segment to the penetration percentage of the universe. In one embodiment, merchants are selected based on their having relatively higher penetration percentage and index when compared to others as well as having a high enough spend per account in the segment base. In other embodiments, national merchants may be chosen over regional ones, so that enough distribution/locations are present to provide wider penetration for the mailing or communication. In other embodiments, such as where a larger base of population is involved, there will be more opportunities to combine regional merchants targeting specific and different geographies in the same merchant set. Qualitative and strategic considerations may also be applied to define the target merchants.

In one embodiment, the merchant selection process may include querying each merchant to determine whether the merchant desires to be included in the program. Those merchants who agree to participate may create one or more targeted offers. In some embodiments, the offers may be based on accountholder spending profiles (e.g., based on the most recent period for which profile data is available). In other embodiments, other profile data may be used, such as when attempting to re-engage formerly active accounts that have gone dormant. In one embodiment, the profiles may be broken into 4 major categories based on spending at the merchant compared to the overall merchant category: (a) High Loyal, (b) Medium Loyal, (c) Low Loyal, and (d) Merchant Inactive (new customers). In practice, other division criteria may be used and the number of divisions may vary. In one embodiment, merchants may provide 3 or 4 offers in terms of escalation based on spend limit or number of transactions and trial offers to incentivize and acquire new customers, to appropriately target these categories.

A merchant coalition may be formed that may include merchants whose offers may be included in the final mailing. The merchant coalition may include a subset of merchants from the merchant category. The subset may include one or more merchants or may also include the entire merchant category. For example, the merchant coalition may include merchants who agree to participate in the program. In another embodiment, the merchant coalition may include merchants identified to have the highest customer spend for a particular industry. In one embodiment, the merchants from the merchant coalition agree to participate in the unified mailing to save on the cost of performing individual analyses and to save on postage, telemarketing, or other marketing communications costs.

In one embodiment, based on the final list of participating merchants, the target accountholder base of cardholders is further analyzed to include customers that have made purchases at the merchants on this list. These cardholders are scored based on how many merchants they have made purchases at during a set duration of time. In other embodiments, a purchase cluster analysis is also used to determine accounts that haven't purchased at the selected merchants but are most likely to given their attitudinal and other lifestyle characteristics. Scoring may include the results of the purchase cluster analysis. For example, the accountholders that have purchased at most of the merchants or are eligible to receive most of the offers may be given priority over cardholders that qualify with less merchants and may be scored accordingly. In other embodiments, the target accountholder base may include customers who have few or no purchases at the merchants on the final list, for example, where the program goals are to attract new customers or expand merchant offerings into new population segments. The scoring function may vary according to the program goals as well. For each accountholder, the set of offers targeted to the accountholder, based at on the customer's loyalty category with respect to the offer's merchant, may be selected (block 712). In one embodiment, the accountholder's score may determine whether the customer ultimately receives their offer package. Accountholders with a score above a threshold may receive the offers while those below the threshold may not receive the offers.

In some embodiments, the selected list of accounts may be sent to the participating issuers or to other data clearinghouses to apply suppression based on marketing preferences, credit delinquency, closed accounts, etc., before the communication is generated, or before a fulfillment entity is involved. Those entities may also provide mailing address information based on the account identifiers.

The list of customers may be sent to a fulfillment entity. Where multiple issuers are involved, or where there is the potential for multiple accounts to be held by a single cardholder or within a single household, a de-duplication process is invoked to prevent a single offer from being mailed multiple times to the same household (unless duplicate offers are intended or desired).

The unique offers for each customer may be packaged, and the offer package may be sent to the customer (block 714). In the event alternative communication channels are employed, such as email, telemarketing, or other approaches, those channels are invoked in lieu of or in addition to a direct mailing.

In another embodiment, during and after promotion, detailed performance metrics based on spend and transactions made at the merchants may be provided to the issuers and merchants. The reports may include comparison of the targeted accounts to a control group. For example, spending volumes at the participating merchants, or in various merchant types for targeted cardholders versus non-targeted cardholders and/or targeted cardholder spending levels before and after the targeted offer may be provided.

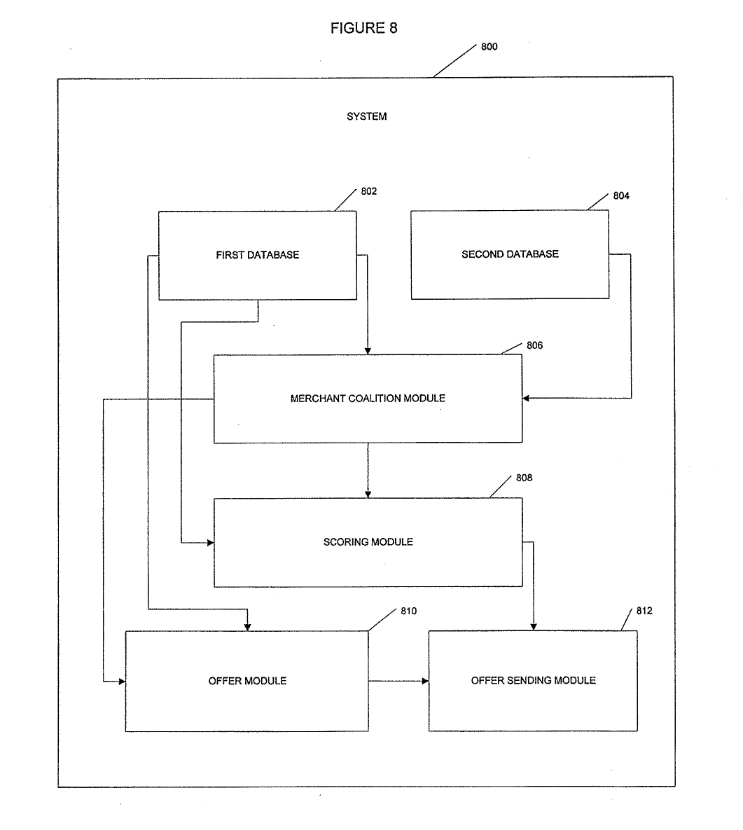

FIG. 8 depicts example components according to some embodiments of the described subject matter. A system 800 includes a first database 802 for storing customer data. The customer data may include data for the customers who satisfy a customer selection criteria, for example, affluent customers. The customers satisfying the customer selection criteria may be grouped into a customer class. A second database 804 may store merchant profiles for one or more merchants. The merchant may include those merchants who satisfy a merchant selection criteria. Merchants satisfying the merchant selection criteria may include those merchants chosen based on analyzing customer transactions with the merchants, for example, merchants who have a high customer spend with respect to the customer class.

A merchant coalition module 806 may identify merchants from the merchant category for inclusion in a merchant coalition. The merchant coalition module may analyze customer data. A scoring module 808 may score the customers within the customer class based on the number of customer transactions, or the number of particular types of customer transactions, with merchants in the merchant coalition. An offer module 810 may, for each merchant within the merchant coalition and each customer within the customer class, select one or more offers based on the customer's loyalty with respect to the particular merchant. An offer sending module 812 may send the group of offers for each customer based at least in part on the score of the customer.

The foregoing merely illustrates the principles of the described subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the described subject matter and are thus within the spirit and scope of the described subject matter.

What is claimed is:

1. A method for targeting an offer to a plurality of customers comprising:
obtaining a merchant category associated with a merchant;
retrieving transaction data for a plurality of customers from a customer transaction database;
assigning each of said plurality of customers a loyalty ranking with respect to said merchant, based at least in part on comparing each customer's transactions at said merchant to said customer's transactions with at least one other merchant associated with said merchant category during a predetermined period of time;
assigning at least a portion of each of said plurality of customers a category spend ranking based at least in part on the customer's total purchases at least two merchants associated with said merchant category; and
determining whether to send a predetermined incentive offer to each of said at least a portion of each of said plurality of customers based on said loyalty ranking and said category spend ranking.

2. The method of claim 1, wherein said customer loyalty ranking is based at least in party on the ratio of the number of said customer's transactions conducted with said merchant to the number of said customer's transactions conducted with all merchants associated with said merchant category.

3. The method of claim 1, wherein said determining whether to send a predetermined offer is also based on whether said customer is geographically eligible for said offer.

4. A computer system including one or more processors and memory for targeting an offer to a customer, comprising:
a first database for storing profiles for one or more merchants, each merchant associated with at least one merchant category;
a second database for storing transaction data for said customer;
a loyalty module for determining, for a merchant within said merchant category, a customer loyalty ranking with respect to said merchant based at least in part on comparing said customer's transactions at said merchant with said customer's transactions with other merchants in said merchant category and assigning said customer to a loyalty category based at least in part on said customer loyalty data;
a category spend module for determining said customer's total category purchases at all merchants associated with said merchant category over a predetermined period of time;
an offer module for determining whether to send said offer to said customer, based at least in part on said customer loyalty ranking and said customer's total category purchases.

5. A method operable on a computer system for sending customized offers from a plurality of merchants to a plurality of payment cardholders having payment accounts held by at least one payment card issuer, comprising:
determining a cardholder selection criteria corresponding to spending habits of cardholders to which said offer is targeted;
extracting from a first database of cardholder transaction data, a list of a payment card accounts exhibiting said cardholder selection criteria;
scoring each payment card account on said list based on expected future transaction activity of said payment card account at said plurality of merchants;
associating said payment card account with a payment cardholder;
selecting, for each of said plurality of merchants, an offer to be presented to a plurality of said payment cardholders, based on said scoring step;
generating and presenting to the associated cardholder a customized offer for each of said plurality of said payment cardholders.

6. A method for automatically segregating multiple payment card accounts, each having at least one associated cardholder, into a plurality of purchase clusters, comprising:
receiving, from a first database of payment card account data, data relating to transactions conducted using a plurality of payment card accounts at a plurality of merchant categories over a predetermined time period;
altering said payment card account data to correct for seasonal spending variability at said plurality of merchant categories to form adjusted payment card account data;
deriving a candidate cluster solution using at least said adjusted payment card account data, said candidate cluster solution consisting of a plurality of account clusters, each account cluster containing at least one of said payment card accounts;
determining, for each one of said plurality of account clusters derived, at least one merchant category at which the accounts contained in said account cluster have statistically abnormal purchasing activity as compared to the purchasing activity of a plurality of payment card accounts in a plurality of the other account clusters; and
generating a list of payment card accounts contained in at least one of said plurality of account clusters.

7. The method of claim 6, wherein said determining involves comparing the percentage of accounts in said one of a plurality of account clusters with purchasing activity exceeding a predetermined threshold at least one merchant in said merchant category to the percentage of accounts in said plurality of payment card accounts in a plurality of the other account clusters with purchasing activity exceeding said predetermined threshold at least one merchant in said merchant category.

8. The method of claim 7 wherein said predetermined threshold is 0 currency amount.

9. The method of claim 7 wherein said predetermined threshold is 0 transactions.

10. The method of claim 6, wherein said determining involves comparing the total currency amount spent by accounts in said one of a plurality of account clusters at a plurality of merchants in said merchant category to the total currency amount spent by said plurality of payment card accounts in a plurality of the other account clusters at said plurality of merchants in said merchant category.

11. The method of claim 6, wherein said determining involves comparing the total number of transactions performed using by accounts in said one of a plurality of account clusters at a plurality of merchants in said merchant category to the total number of transactions performed using said plurality of payment card accounts in a plurality of the other account clusters at said plurality of merchants in said merchant category.

12. The method of claim 6, wherein said altering said payment card account transaction data further includes identifying at least one inactive account based on an inactivity criteria; and normalizing at least a portion of said payment card account data associated with said at least one inactive account.

13. The method of claim 12, wherein said normalizing comprises:
obtaining a plurality of profile variables associated with said at least one inactive account;
for at least one of said plurality of profile variables, calculating a normalized profile variable by dividing said profile variable value by the sum of the values of a plurality of other said profile variables associated with said at least one inactive account.
